(19) United States
(12) Patent Application Publication
(10) Pub. No.: US 2006/0284826 A1
(43) Pub. Date: Dec. 21, 2006

(54) Liquid crystal display device, method of driving the same

(75) Inventor: Seiji Kawaguchi, Osaka (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd, Minato-ku (JP)

(21) Appl. No.: 11/441,091

(22) Filed: May 26, 2006

(30) Foreign Application Priority Data
May 26, 2005 (JP) 2005-154306

(51) Int. Cl. G09G 3/36

(52) U.S. Cl. 345/102

(57) ABSTRACT

The liquid crystal display device includes an active matrix type liquid crystal display panel using OCB mode liquid crystal, a source/gate driving unit, a backlight and a backlight control unit which controls the backlight to turn on/off periodically, the backlight control unit periodically assigns on and off periods of the backlight, the ON/OFF period of the backlight is controlled such that the relationship between the assigned ON/OFF period T_{B} of the backlight and a switching period T_{G} of a gate line in the liquid crystal display panel is given by T_{B}=(1/n)·T_{G} (n: natural number)

### BACKGROUND OF THE INVENTION

1. Field of the Invention

The present invention relates to a liquid crystal display device using OCB mode liquid crystal and a method of driving the same.

2. Related Art of the Invention

Liquid crystal display devices are thin and high quality; therefore, as alternatives to conventional Braun tubes, the range of their uses has been increased in recent years.

FIG. 4 is a general drawing of a liquid crystal display device. In a liquid crystal display device 400, a liquid crystal panel 410 is composed of a plurality of pixels 411 arranged in a matrix form, including a TFT 411a, a picture electrode 411b connected via the TFT 411a, a liquid crystal layer 411d retained between the picture electrode 411b and an opposing electrode 411c, and a capacitance Cs connected to a common electrode 411e and the picture electrode 411b. A source electrode of each TFT 411a within the liquid crystal panel 410 is connected to a source driver 420 via a source line 412, and gate electrode of each TFT 411a is connected to a gate driver 430 via a gate line 413, respectively.

The TFT 411a is opened and closed by a gate voltage Vg applied by the gate driver 430, and a video signal Vs from the source driver 420 is supplied to the picture electrode 411b. A voltage Vcom is applied to the opposing electrode 411c and the common electrode 411e. This maintains liquid crystal capacitance C_{LC} and auxiliary capacitance Cs composing each pixel 411 at a predetermined gradation of voltage corresponding to the video signal Vs. Optical source light from a backlight 110 provided on the back face of the liquid crystal panel 410 is received through a diffusion board 120 and an image is displayed.

In the figure, a source/gate control unit 440 is a unit to which electrical power is supplied from an external power source and which receives input of the video signal to be displayed and the like and drives the source driver 420 and the gate driver 430 based on the input. The backlight 450 also turns on and off responding to the operation of the source/gate driving unit 440 by the source/gate control unit 440.

Compared to self-luminescence type displays such as Braun tubes, TN (Twisted Nematic) mode liquid crystal panels currently widely used for the liquid crystal layer 411d in the liquid crystal panel 410 have poor image quality. For example afterimage remains when displaying motion picture, due to narrow viewing angle, low response speed, and their holding type liquid crystal elements.

On the other hand, in recent years, OCB (Optically Compensated Bend) mode liquid crystal has been suggested (e.g., see Patent Document 1).

OCB mode liquid crystal has advantages that it can sufficiently support display of motion picture and a large screen due to its high response speed and wide viewing angle compared to TN mode liquid crystal and it can provide a thin and large screen display with low power consumption compared to Braun tubes.

OCB mode liquid crystal is characterized in that orientation states of liquid crystal molecules are transferred from a so-called splay orientation to a bend orientation by applying comparatively high voltage and an image is displayed by the bend orientation state. In OCB mode liquid crystal, the response speed of liquid crystal molecule is significantly increased compared to the TN orientation liquid crystal display panels; therefore OCB mode liquid crystal is suitable for displaying motion picture. Since liquid crystal molecules in bend orientation state are inclined each other to opposite directions on upper and lower surface of a glass substrate, optical compensation will be made. Further, the above described phase difference film compensates the phase difference of a liquid crystal layer. As a result, wider viewing angle than that of TN orientation liquid crystal display panel can be obtained.

As described above, in the OCB mode liquid crystal display device, an orientation state of liquid crystal molecules are transferred from the splay orientation to the bend orientation and an image is displayed with the bend orientation state being maintained. However, even in an image display period, if strong voltage required for maintaining bend orientation is not applied over a long period, for example during white display, the orientation state of liquid crystal molecules may be reversely-transferred to the initial splay orientation. In the splay orientation state, bad image such as orientation defect or point defect occurs, and good image can not be displayed.

In order to prevent such counter-transfer of orientation state of liquid crystal molecules, a technology is known that a non-video signal, which is different from the video signal, is input to a picture electrode during a certain period (e.g., see Japanese Patent Laid-Open No. 2003-295156). A signal is used as the non-video signal, which performs white display when a comparatively low voltage is applied and which performs black display when a comparatively high voltage is applied as in normally white mode.

FIG. 5 shows a timing chart in which a high voltage as the non-video signal is inserted during an image display period. As shown in FIG. 5, within a display period of one field, a period of about 20% of the entire picture period is provided as a black period for displaying a black signal as the non-video signal, so as to apply a voltage for black display during such a time) (e.g., see “first line display” in FIG. 5).

In this way, since a comparatively high voltage is applied to a picture electrode by writing the non-video signal during the predetermined non-video signal period, the bend orientation can be maintained. Also, since afterimage is eliminated by interposing the black display, blur of an image can be prevented.

Presently, cold cathode tubes are primarily used as backlights for liquid crystal display devices. However, they can not control light amount, that is, they cannot perform dimming. In order to enable the backlights to perform dimming, a technology is known that adjusts light amount during the entire display period by controlling turn-on/off of the backlight. This also has effects of saving light amount and preventing temperature of the device from rising.

In the example shown in FIG. 4, brightness adjustment is performed by alternating ON and OFF periods of the backlight once within one field period. Within one field period, the image display period is substantially the ON period of the backlight.

If such control with the backlight ON/OFF is applied to a liquid crystal display device with OCB mode liquid crystal, the following problem occurs. That is, as shown in FIG. 5, in image display using OCB mode liquid crystal, display of each line is performed after providing a picture period and black display period provided in the latter part of the picture period, as described above. When the gate lines are driven sequentially from the top of the panel, the picture period and the black period are shifted rightward on the time chart over the entire field period, with the number of gate lines being one cycle, while the ON and OFF periods of the backlight are fixed for each field period.

When the first gate line is driven, the entire picture period is included in the backlight ON period, a portion of the picture period and the entire black period are included in the OFF period, therefore all the backlight ON period coincides with video display period and video 1 is displayed on a screen. However, since the picture period and the black period move within one field period according to the scanning drive of the gate line, the black display period is included in the backlight ON period and the picture period is included in the backlight OFF period when displaying the second line; therefore a display period of the video 1 is shorter than that of the first line. Similarly, the each video of the third line is displayed during a shorter period.

Thereafter, the picture period and black period will periodically appear during both the backlight ON and OFF periods, and substantial video display period in one field period will be periodically varied as the gate line drive proceeds.

This variation appears as the variation of brightness for each gate line, and as shown in FIG. 6, it is recognized as brightness variation 600 occurring periodically.

In view of foregoing, it is an object of the present invention to provide a liquid crystal display device using OCB mode liquid crystal and, having a backlight which performs dimming by ON/OFF control, and a method of the liquid crystal display device, the liquid crystal display device allowing for reducing or eliminating brightness variation for proper display.

### SUMMARY OF THE INVENTION

In order to achieve the above object, a first aspect of the present invention is a liquid crystal display device comprising:

an active matrix type liquid crystal display panel which is used OCB mode liquid crystal, a driving unit which drives said liquid crystal display panel,

a backlight which illuminates said liquid crystal display panel, and

a backlight control unit which controls said backlight to periodically turn on/off,

wherein said driving unit drives such that a picture period during which a video signal is displayed on said liquid crystal display panel and a non-display period during which a non-display signal at a predetermined high voltage is displayed on said liquid crystal display panel are assigned within a period in units of field or frame,

wherein said backlight control unit controls the cycle of ON/OFF periods of said backlight such that

the ON periods and the OFF periods of said backlight are periodically assigned within said picture period of each horizontal display period which is said period in units of field or frame, and

the relationship between the assigned cycle of ON/OFF period T_{B} of said backlight and a switching period T_{G} is given by:

T_{B}=(1/n)·T_{G} (n: natural number).

A second aspect of the present invention is a liquid crystal display device comprising:

an active matrix type liquid crystal display panel which is used OCB mode liquid crystal,

a driving unit which drives said liquid crystal display panel,

a backlight which illuminates said liquid crystal display panel, and

a backlight control unit which controls said backlight to periodically turn on/off,

wherein said driving unit drives such that a picture period during which a video signal is displayed on said liquid crystal display panel and a non-display period during which a non-display signal at a predetermined high voltage is displayed on said liquid crystal display panel are assigned within a period in units of field or frame,

wherein said backlight control unit controls said backlight such that

the cycle of ON/OFF periods of said backlight is 11 or more within said picture period of each horizontal display period which is said period in units of field or flame.

A third aspect of the present invention is a liquid crystal display device comprising:

an active matrix type liquid crystal display panel which is used OCB mode liquid crystal,

a driving unit which drives said liquid crystal display panel,

a backlight which illuminates said liquid crystal display panel, and

a backlight control unit which controls said backlight to periodically turn ON/OFF,

wherein said driving unit drives such that a picture period during which a video signal is displayed on said liquid crystal display panel and a non-display period during which a non-display signal at a predetermined-high voltage is displayed on said liquid crystal display panel are assigned within a period in units of field or flame,

wherein said backlight control unit controls said backlight such that ON/OFF of said backlight is switched at a frequency of 4 kHz or more.

A fourth aspect of the present invention is the liquid crystal display device according to any one of the first to the third aspects of the present invention, wherein said predetermined high voltage is a voltage for black display.

A fifth aspect of the present invention is a method of driving a liquid crystal display device having an active matrix type liquid crystal display panel using OCB mode liquid crystal, a driving unit which drives said liquid crystal display panel, and a backlight which illuminates said liquid crystal display panel, the method comprising steps of:

assigning by said driving unit a picture period during which a video signal is displayed on said liquid crystal display panel and a non-display period during which a non-display signal at a predetermined high voltage is displayed on said liquid crystal display panel within a period in units of field or frame,

controlling the cycle of ON/OFF periods of said backlight such that

the ON periods and the OFF periods of said backlight are periodically assigned within said picture period of each horizontal display period which is said period in units of field or frame, and

the relationship between the assigned cycle of ON/OFF period T_{B} of said backlight and a switching period T_{G} is given by:
T_{B}=(1/n)·T_{G} (n: natural number).

A sixth aspect of the present invention is a method of driving a liquid crystal display device having an active matrix type liquid crystal display panel which is used OCB mode liquid crystal, a driving unit which drives said liquid crystal display panel, and a backlight which illuminates said liquid crystal display panel, the method comprising steps of:

assigning by said driving unit a picture period during which a video signal is displayed on said liquid crystal display panel and a non-display period during which a non-display signal at a predetermined high voltage is displayed on said liquid crystal display panel within a period in units of field or frame, and
controlling said backlight such that the cycle of ON/OFF periods of said backlight is 11 or more within said picture period of each horizontal display period which is said period in units of field or frame.

A seventh aspect of the present invention is a method which drives a liquid crystal display device having:

an active matrix type liquid crystal display panel which is used OCB mode liquid crystal,

a driving unit which drives said liquid crystal display panel, and

a backlight which illuminates said liquid crystal display panel, the method comprising steps of:

assigning by said driving unit a picture period during which a video signal is displayed on said liquid crystal display panel and a non-display period during which a non-display signal at a predetermined high voltage is displayed on said liquid crystal display panel within a period in units of field or frame, and

controlling said backlight such that ON/OFF of said backlight is switched at a frequency of 4 kHz or more.

An eighth aspect of the present invention is the method of driving the liquid crystal display device according to any one of the fifth to the seventh aspects of the present invention, wherein said predetermined high voltage is a voltage for black display.

A ninth aspect of the present invention is a program which causes a computer to function as said backlight control unit in the liquid crystal display device according to the first aspect of the present invention.

A tenth aspect of the present invention is a recording medium which records the program according to the ninth aspect of the present invention, wherein the recording medium can be processed by a computer.

According to the above invention, in a liquid crystal display device using OCB mode liquid crystal, having a backlight which performs dimming by ON/OFF control, brightness variation can be reduced or eliminated for proper display.

### BRIEF DESCRIPTION OF THE DRAWINGS

FIG. 1 is a liquid crystal display device according to the first to third embodiments of the present invention.

FIG. 2 is a timing chart of the liquid crystal display device operation according to the first embodiment of the present invention.

FIG. 3 is a timing chart of the liquid crystal display device operation according to the second embodiment of the present invention.

FIG. 4 is a block diagram of a prior art liquid crystal display device.

FIG. 5 is a timing chart of a prior art liquid crystal display device operation.

FIG. 6 schematically shows brightness variation on a screen.

### DESCRIPTION OF SYMBOLS

100 liquid crystal display device
110 backlight
120 diffusion board
130 backlight control unit
410 liquid crystal display panel
420 source driver
430 gate driver
440 source/gate driving unit

### PREFERRED EMBODIMENTS OF THE INVENTION

Embodiments of the present invention will be described below with reference to the drawings.

### Embodiment 1

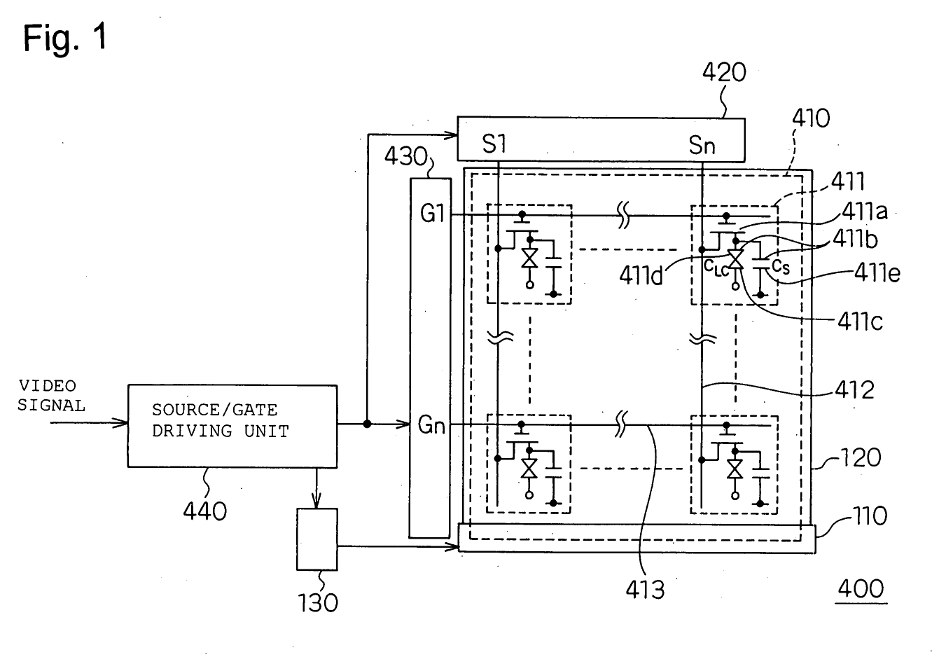

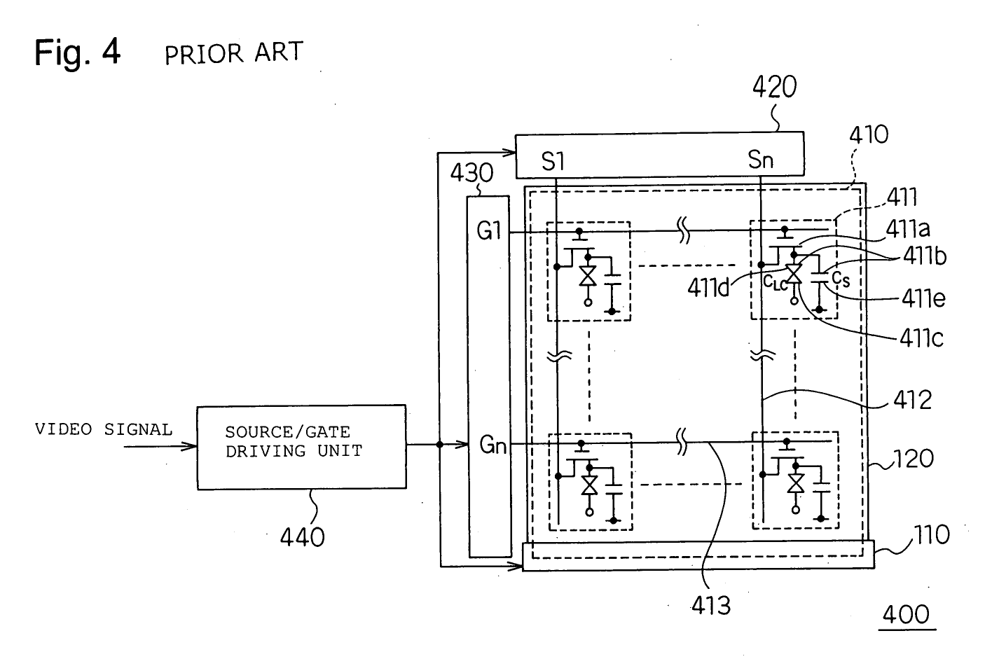

FIG. 1 is a block diagram of a liquid crystal display device 100 according to a first embodiment of the present invention. In the figure, the same or similar parts as those shown in FIG. 4 showing a conventional embodiment are denoted by the same reference numerals and detailed description will be omitted. A backlight 110 is a unit which illuminates a liquid crystal display panel 410 from backward and a backlight control unit 130 is a unit which controls ON/OFF of the backlight 110. Although in FIG. 1 the backlight 110 is provided only on the bottom of the liquid crystal display panel 410, a diffusion board 120 is provided over the back of the entire liquid crystal display panel 410 and irradiation light from the backlight 110 illuminates the entire liquid crystal display panel 410 through the diffusion board 120.

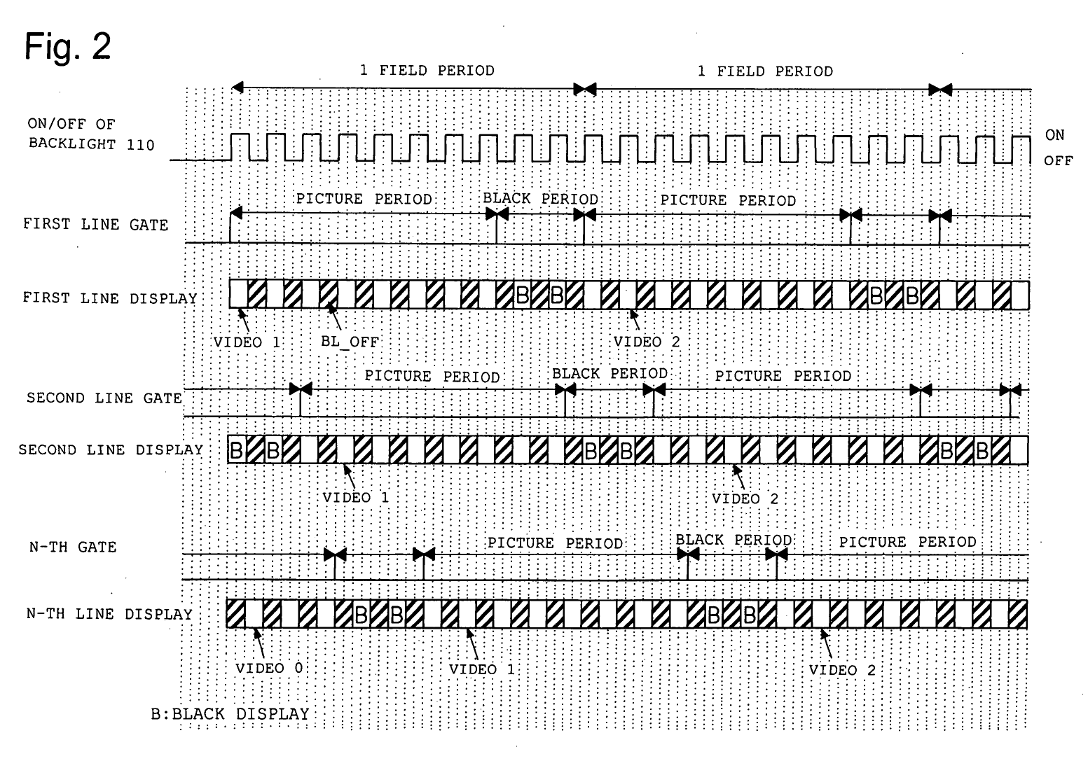

The operation of the liquid crystal display device having the above configuration according to the embodiment of the present invention will now be described with reference to a timing chart in FIG. 2 and an embodiment of a driving method of the liquid crystal display device according to the present invention will be described.

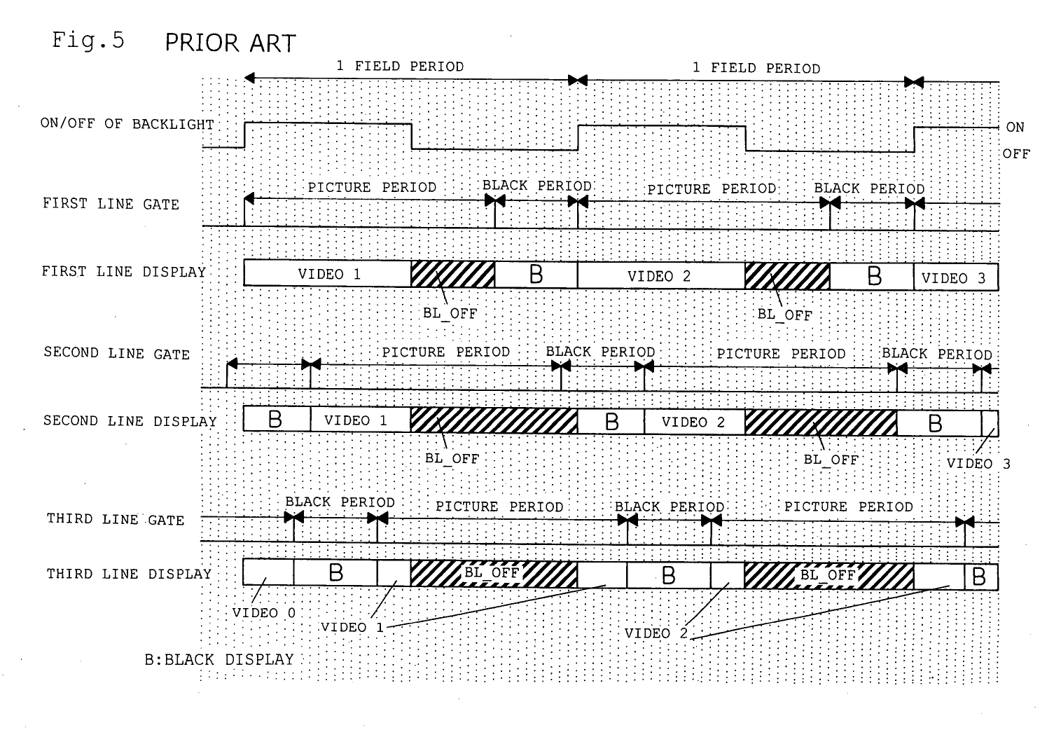

As shown in FIG. 2, in the present embodiment, drive of the gate line by the source/gate driving unit 440 and assignment of the picture period and the black period in one field period is similar to the conventional embodiment shown by a timing chart in FIG. 5, and the present embodiment is characterized in that the cycle of the ON/OFF period of the backlight 110 is made different. That is, in the conventional embodiment, the ON/OFF period of the backlight 110 is one cycle within one field period and the cycle of ON/OFF period was longer than the time length of the picture period of each gate line. This causes the time length of the picture period and the black period for each gate line in the liquid crystal display panel 410, corresponding to each ON/OFF period of the backlight within one field period to increase or decrease as the scanning of the gate line proceeds and then the picture period within the backlight ON period during which video display is substantially possible to be made different for each gate line, so that brightness variation occurs.

On the other hand, in the present embodiment, the backlight control unit 130 sets the cycle of the ON/OFF period within one field period to 10 and makes the cycle of the ON/OFF period of the backlight 110 shorter than the length of the picture period of each gate line. This always causes a plurality of the backlight ON periods to be assigned to the picture period of each gate line.

Further, control is performed so that ON/OFF period T_{B} may establish the following equation:
T_{B}=(1/n)·T_{G} (n: natural number) (Equation 1)

where T_{B} is the ON/OFF period of the backlight, and T_{G} is a scanning period between the gate lines that is the value obtained from dividing a vertical scanning period by the number of the gate lines. In FIG. 2, n=2 is assumed.

With these controls, the backlight ON/OFF period appears periodically in one field (in FIG. 2, 10 cycles per one field period) and the picture period and the black period are shifted rightward in the Figure as the scanning proceeds. Since the unit of shifting is n times the cycle of the backlight ON/OFF period (twice, in FIG. 2), the number of backlight ON period newly added to the picture period is equal to the number of the backlight ON period passing the picture period. In FIG. 2, two backlight ON periods will pass the picture period during transferring from the first line to the second line.

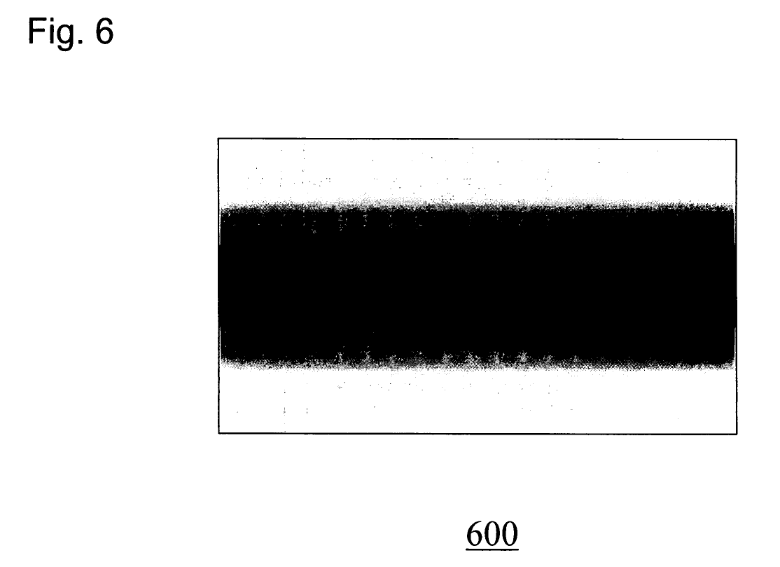

Accordingly, the number of the backlight ON period corresponding to the picture period is not changed as the scanning of the gate line proceeds. In FIG. 2, the eight backlight ON periods are always included in one picture period in every gateline display. This means that the backlight ON period included in the picture period of each gate line is the same time length in every gate line in one field period. This allows the same brightness to be obtained in every gate line display; therefore this allows the brightness variation shown in FIG. 6 to be eliminated.

Although the number of the backlight ON/OFF periods is 10 per one field period in the above description, the number of periods is not limited, as long as the relation in (equation 1) holds. The backlight control unit 130 may hold the scanning period between the gate lines T_{G} in the relationship of (equation 1) by storing it as a constant, thereby control may be performed. Alternatively, the backlight control unit 130 may acquire the scanning period between the gate lines T_{G} from the source/gate driving unit 440. In this case, the relationship of (equation 1) can be maintained according to the operating condition of the source/gate driving unit 440 to perform proper control at any time.

### Embodiment 2

A liquid crystal display device according to a second embodiment of the present invention has a similar configuration as the first embodiment except for the control method of the backlight control unit 130. Accordingly, its configuration can be seen in FIG. 1 and detailed description will be omitted.

In the liquid crystal display device of the second embodiment, the backlight control unit 130 is characterized in that the cycle of the backlight ON/OFF period is 11 or more per one field period independently of the length of scanning period between the gate lines.

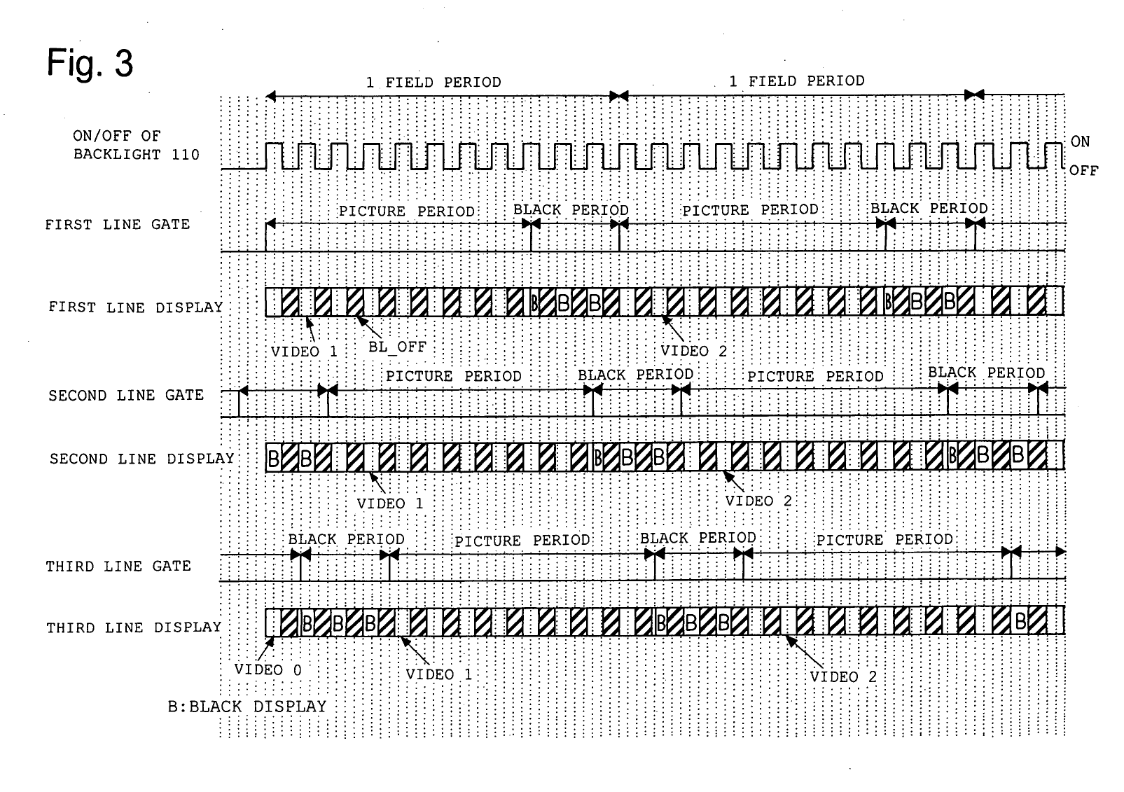

In this case, since the cycle of ON/OFF period of the backlight 110 is shorter than the length of the picture period of each gate line, a plurality of the backlight ON periods will always be assigned to the picture period of each gate line. In a time chart shown in FIG. 3, 11 backlight ON periods are assigned to the first line as with the first embodiment. In the present embodiment, as with the conventional embodiment, the time length of the picture period (and black period) corresponding to the backlight ON/OFF period respectively in one field period increases or decreases as the scanning of the gate line proceeds. However, the change in the picture period length in the backlight ON period is shorter than that of the conventional embodiment shown in FIG. 5. In the example shown, the number of the backlight ON period is eight and about a half assigned to video 1 in the first line, the backlight ON period assigned to video 1 in the second line is eight and about a third, the backlight ON period assigned to video 1 in the third line is eight and about a fifth. These changes in the length of the picture period within the backlight ON period are smaller than those of the conventional embodiment shown in FIG. 5, thus brightness variation of each gate line is reduced. This allows brightness variation of displayed image to be reduced. The backlight ON period assigned to each line video is not precisely limited to the above each period. Rather, similar effect is obtained by assigning as appropriate a period during which brightness variation of the gate line is small.

As described in the conventional embodiment, in one field period of each gate line, since the ratio between the picture period and the black period is (picture period: black period=4:1, i.e. black period is 20% of all) at the maximum, the backlight ON/OFF periods could be conventionally controlled to the extent of about five cycles. If the operation is at 11 cycles or more that is shorter than this, the advantage of the present invention is obtained as shown.

### Embodiment 3

A liquid crystal display device according to a third embodiment of the present invention has a similar configuration as the second embodiment, and is characterized in that the backlight control unit 130 causes ON/OFF period of the backlight to be shorter than that of the second embodiment and ON/OFF of the backlight is switched at a frequency of 4 kHz or more regardless of the length of the picture period of each gate line.

As described in the second embodiment, by taking the cycle of ON/OFF period of the backlight to be shorter than the length of the picture period of each gate line, and assigning a plurality of the backlight ON periods to the picture period of each gate line, variation in brightness for each gate line are reduced, allowing the brightness variation shown in FIG. 6 to be eliminated.

However, the brightness variation on an image which is numerically evaluated does not always correspond to the degree of brightness variation recognized by humans.

For this reason, the third embodiment of the present invention involves switching ON/OFF of the backlight at a higher rate so that a viewer of the image recognizes that the brightness variation as shown in FIG. 6 is eliminated, and controlling ON/OFF of the backlight at higher frequency.

Table 1 shows sensory evaluation when the cycle of the ON/OFF period of the backlight by the backlight control unit 130 is changed in units of Hz by converting the cycle of the ON/OFF period to a frequency of ON/OFF switching. As a displayed image to be evaluated, an image was used which is obtained from applying a video signal corresponding to white display at brightness of 500 candela on the entire display. The number of evaluators was 10. Images at different ON/OFF switching frequencies of the backlight were evaluated.

Images were set at 300 Hz as a comparative example converted from five cycles per 1 field period which is a conventional cycle of backlight ON/OFF period into frequency, which is described in the second embodiment, at 660 Hz as an Example 1 converted from the cycle of the backlight control into frequency according to the second embodiment, at higher frequency of 4 and 8 kHz as examples 2 and 3, respectively. Note that the backlight control unit 130 controlled ON/OFF switching by PWM scheme. This configuration was also used for the comparative example.

TABLE 1

| | | | Difference between |
|---|---|---|---|
| | PWM | | brightest gate line |
| | frequency | Determina- | and darkest gate |
| | (Hz) | tions | line (%)* |
| Comparative | 300 | x | 20 |
| example | | | |
| Example 1 | 660 | ▴ | 9 |
| Example 2 | 4000 | ◯ | 1.5 |
| Example 3 | 8000 | ⊚ | 0.75 |

$\begin{matrix}* Difference between \\ brightest gate line and \\ darkest gate line\end{matrix} = \frac{\begin{matrix}( Brightness of brightest gate line - \\ \text{Brightness of darkest gate line} )\end{matrix}}{\text{Brightness of brightest gate line}} \times 100 ( \% )$

The number of evaluators: 10

The number of evaluators who recognized brightness variation versus determination results

| | |
|---|---|
| 0: | ⊚ |
| 1-2: | ∘ |
| 3-6: | ▴ |
| 7-: | x |

As shown in the table, the difference between a gate line at which brightest display in the image occurs and a gate line at which darkest display occurs was 9%. This is numerically improved over the comparative example (in the case that the difference between a gate line at which brightest display in the image occurs and a gate line at which darkest display occurs is 20%), but when determined by evaluators, some evaluators recognized brightness variation.

In Example 2, the difference between a gate line at which brightest display in the image occurs and a gate line at which darkest display occurs was 1.5%. Also when determined by evaluators, few evaluators recognized brightness variation. Therefore, brightness variation was substantially eliminated.

In Example 3, when determined by evaluators, no one recognized brightness variation. Therefore, brightness variation was eliminated.

From the foregoing, it can be seen that by switching backlight ON/OFF at high frequency which is at least 4 kHz or more, image can be obtained from which brightness variation is eliminated for viewers.

Depending on gradation, colors and the like of a displayed image, and even the environment around the display device, even the difference between a gate line at which brightest display in the image occurs and a gate line at which darkest display occurs is numerically the same, viewers may recognize that brightness variation is sufficiently reduced. In view of the situation, switching may be reduced to 1 kHz. It goes without saying from Example 3 that switching of 8 kHz or more can eliminate brightness variation independently of the quality of an image and the environment around the display device.

Although the backlight ON/OFF period is synchronized with a vertical scanning period in the first embodiment, the switching of backlight ON/OFF may or may not be synchronized with a vertical scanning period in the third embodiment. In this case, if the switching frequency is particularly low, controlling the switching to be asynchronous causes the position of brightness variation to be moved, and is effective for maintaining the quality of the displayed image.

Furthermore, in the above first embodiment, although the scanning period between gate lines T_{B} is described as the period between the time at which one gate line turns on and the time at which the next gate line turns on, if this period is the same as a horizontal scanning period, the value of the horizontal scanning period can be used as T_{B}.

In each of the above embodiments, the liquid crystal display panel 410 corresponds to an active matrix type liquid crystal panel of the present invention, and the source driver 420, the gate driver 430, the source line 412, the trine 413 and the source/gate control unit 440 correspond to a driving unit of the present invention, the backlight 110 corresponds to a backlight of the present invention, and the backlight control unit 130 corresponds to a backlight control unit of the present invention.

In each of the above embodiments, although black display is used as a non-display period of the present invention, it may be a high voltage substantially providing black display. In the case of normally black mode, it may be a high voltage providing white display or substantial white display.

In each of the above embodiments, although one field period is used as the period of the present invention, the period may be one frame.

A program according to the present invention may be a program which causes a computer to execute functions of all or some units of the above described liquid crystal display device of the present invention, the program cooperating with the computer.

The present invention may be a medium carrying a program which causes a computer to execute functions of all or some units of the above described liquid crystal display device of the present invention, the medium being computer-readable and the read program cooperating with the computer to execute the functions.

“Some units” of the present invention mean some of a plurality of the units or some functions in one unit.

Some devices of the present invention mean some of a plurality of the devices, some units in one device or some functions in one unit.

A computer-readable recording medium recording the program of the present invention is also included in the present invention.

An application of the program of the present invention may be an aspect which is recorded in a computer-readable recording medium and cooperates with a computer.

An application of the program of the present invention may be an aspect which transmits via transmission medium and is read by a computer and cooperates with the computer.

The recording media include ROM and the like, and transmission media include transmission mechanism such as the Internet, light, radio wave, acoustic wave and the like.

The above described computers of the present invention are not limited to pure hardware such as CPU, but may include firmware, OS, and even a peripheral device.

As described above, the configuration of the present invention may be realized as both software and hardware form.

### INDUSTRIAL APPLICABILITY

The liquid crystal display device and the driving method of the liquid crystal display device according to the present invention has effects of allowing for reducing or eliminating brightness variation for proper display in a liquid crystal display device having a backlight which performs dimming by ON/OFF control, and is useful for a liquid crystal display device or the like.

1. A liquid crystal display device comprising:
an active matrix type liquid crystal display panel which is used OCB mode liquid crystal,
a driving unit which drives said liquid crystal display panel,
a backlight which illuminates said liquid crystal display panel, and
a backlight control unit which controls said backlight to periodically turn on/off,
wherein said driving unit drives such that a picture period during which a video signal is displayed on said liquid crystal display panel and a non-display period during which a non-display signal at a predetermined high voltage is displayed on said liquid crystal display panel are assigned within a period in units of field or frame,
wherein said backlight control unit controls the cycle of ON/OFF periods of said backlight such that
the ON periods and the OFF periods of said backlight are periodically assigned within said picture period of each horizontal display period which is said period in units of field or frame, and
the relationship between the assigned cycle of ON/OFF period T_{B} of said backlight and a switching period T_{G} is given by:
T_{B}=(1/n)·T_{G} (n: natural number).

2. A liquid crystal display device comprising:
an active matrix type liquid crystal display panel which is used OCB mode liquid crystal,
a driving unit which drives said liquid crystal display panel,
a backlight which illuminates said liquid crystal display panel, and
a backlight control unit which controls said backlight to periodically turn on/off,
wherein said driving unit drives such that a picture period during which a video signal is displayed on said liquid crystal display panel and a non-display period during which a non-display signal at a predetermined high voltage is displayed on said liquid crystal display panel are assigned within a period in units of field or frame,
wherein said backlight control unit controls said backlight such that
the cycle of ON/OFF periods of said backlight is 11 or more within said picture period of each horizontal display period which is said period in units of field or flame.

3. A liquid crystal display device comprising:
an active matrix type liquid crystal display panel which is used OCB mode liquid crystal,
a driving unit which drives said liquid crystal display panel,
a backlight which illuminates said liquid crystal display panel, and
a backlight control unit which controls said backlight to periodically turn ON/OFF,
wherein said driving unit drives such that a picture period during which a video signal is displayed on said liquid crystal display panel and a non-display period during which a non-display signal at a predetermined high voltage is displayed on said liquid crystal display panel are assigned within a period in units of field or flame,
wherein said backlight control unit controls said backlight such that ON/OFF of said backlight is switched at a frequency of 4 kHz or more.

4. The liquid crystal display device according to any one of claims 1 to 3, wherein said predetermined high voltage is a voltage for black display.

5. A method of driving a liquid crystal display device having an active matrix type liquid crystal display panel using OCB mode liquid crystal, a driving unit which drives said liquid crystal display panel, and a backlight which illuminates said liquid crystal display panel, the method comprising steps of:
assigning by said driving unit a picture period during which a video signal is displayed on said liquid crystal display panel and a non-display period during which a non-display signal at a predetermined high voltage is displayed on said liquid crystal display panel within a period in units of field or frame,
controlling the cycle of ON/OFF periods of said backlight such that
the ON periods and the OFF periods of said backlight are periodically assigned within said picture period of each horizontal display period which is said period in units of field or frame, and
the relationship between the assigned cycle of ON/OFF period T_{B} of said backlight and a switching period T_{G} is given by:
T_{B}=(1/n)·T_{G} (n: natural number).

6. A method of driving a liquid crystal display device having an active matrix type liquid crystal display panel which is used OCB mode liquid crystal, a driving unit which drives said liquid crystal display panel, and a backlight which illuminates said liquid crystal display panel, the method comprising steps of:
assigning by said driving unit a picture period during which a video signal is displayed on said liquid crystal display panel and a non-display period during which a non-display signal at a predetermined high voltage is displayed on said liquid crystal display panel within a period in units of field or frame, and
controlling said backlight such that the cycle of ON/OFF periods of said backlight is 11 or more within said picture period of each horizontal display period which is said period in units of field or frame.

7. A method which drives a liquid crystal display device having:
an active matrix type liquid crystal display panel which is used OCB mode liquid crystal,
a driving unit which drives said liquid crystal display panel, and
a backlight which illuminates said liquid crystal display panel, the method comprising steps of:
assigning by said driving unit a picture period during which a video signal is displayed on said liquid crystal display panel and a non-display period during which a non-display signal at a predetermined high voltage is displayed on said liquid crystal display panel within a period in units of field or frame, and
controlling said backlight such that ON/OFF of said backlight is switched at a frequency of 4 kHz or more.

8. The method of driving the liquid crystal display device according to any one of claims 5 to 7, wherein said predetermined high voltage is a voltage for black display.

9. A recording medium which records a program which causes a computer to function as said backlight control unit in the liquid crystal display device according to claim 1, wherein the recording medium can be processed by a computer.

10. (canceled)
